(19) United States
(12) Patent Application Publication
(10) Pub. No.: US 2026/0367996 A1
(43) Pub. Date: Nov. 19, 2026

(54) LIVE MIGRATION OF A VIRTUAL MACHINE EXECUTING WORKLOADS ON A GPU

(71) Applicant: VMware LLC, Palo Alto, CA (US)

(72) Inventors: Arunachalam Ramanathan, Union City, CA (US); Zexing Jiang, Mountain View, CA (US); Alexander Krits, Austin, TX (US); Matthew D. McClure, Alameda, CA (US); Yanlei Zhao, Saratoga, CA (US)

(21) Appl. No.: 19/208,508

(22) Filed: May 14, 2025

(51) Int. Cl. G06F 9/50

(52) U.S. Cl. CPC G06F 9/5088; G06F 9/5038; G06F 9/5077

(57) ABSTRACT

A virtual machine (VM) that is executing workloads on a GPU is live migrated from a source host computer to a destination host computer. The live migration includes the steps of: while the VM is executing on the source host computer, selectively reading cold data from a frame buffer of the GPU and transferring the selectively read cold data to the destination host computer and then iteratively transferring contents of a system memory of the VM to the destination host computer; suspending the execution of the VM on the source host computer; and while the execution of the VM on the first host computer is suspended, reading remaining data to be transferred from the frame buffer and transferring the remaining data read from the frame buffer and contents of the modified portions of the system memory to the destination host computer.

### BACKGROUND

Computer virtualization is a technique that involves encapsulating a physical computing machine platform into virtual machine(s) executing under control of virtualization software on a hardware computing platform or “host.” A virtual machine (VM) provides virtual hardware abstractions for processor, memory, storage, and the like to a guest operating system. The virtualization software, also referred to as a “hypervisor,” incudes one or more virtual machine monitors (VMMs) to provide execution environment(s) for the virtual machine(s). As physical hosts have grown larger, with greater processor core counts and terabyte memory sizes, virtualization has become key to the economic utilization of available hardware.

Virtualized computing systems can have multiple hosts managed by a virtualization management server. The virtualization management server can facilitate live migration of a VM from one host to another host. A goal of such a migration is to move the VM from source host to destination host with minimal impact on VM performance. This process is described in U.S. Pat. No. 7,484,208 having the title “Virtual Machine Migration,” the entire contents of which are incorporated by reference herein.

Efforts have been made to enable live migration of VMs that run workloads on graphics processing units (GPUs). Live migrating such VMs is challenging for several reasons. The first is the frame buffer size of the GPUs and the second is the dirty rate of the GPU's frame buffer.

### SUMMARY

One or more embodiments provide a method of migrating a virtual machine (VM) that is executing workloads on a GPU from a source host computer to a destination host computer. This method includes the steps of: while the VM is executing on the source host computer, selectively reading cold data from a frame buffer of the GPU and transferring the selectively read cold data to the destination host computer and then iteratively transferring contents of a system memory of the VM to the destination host computer; suspending the execution of the VM on the source host computer; and while the execution of the VM on the first host computer is suspended, reading remaining data to be transferred from the frame buffer and transferring the remaining data read from the frame buffer and contents of the modified portions of the system memory to the destination host computer.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 depicts a first example of a virtualized computing system in which a virtual machine is migrated between a source host and a destination host.

FIG. 2 depicts a second example of a virtualized computing system in which a virtual machine is migrated between a source host and a destination host.

FIG. 3 is a flow diagram depicting a method of migrating a virtual machine between hosts according to a first embodiment.

FIG. 4 is a flow diagram depicting in detail one of the steps of the method of FIG. 3.

FIG. 5 is a flow diagram depicting a method of migrating a virtual machine between hosts according to a second embodiment.

### DETAILED DESCRIPTION

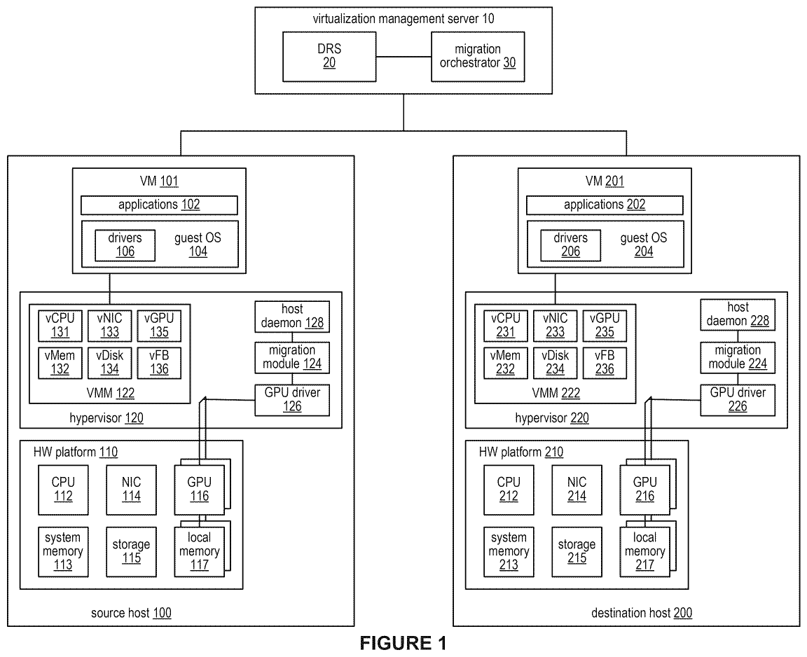

FIG. 1 depicts a first example of a virtualized computing system in which a VM is migrated between a source host and a destination host. The virtualized computing system includes a virtualization management server 10 that manages a plurality of physical host computers, each of which runs virtualization software commonly known as a hypervisor, and VMs running on these host computers with the support of the hypervisors. Virtualization management server 10 may be a physical server that includes a hardware platform containing standard computer hardware components such as a central processing unit (CPU), memory, networking devices, and storage devices, and an operating system running on the hardware platform, or it may be provisioned as a VM that is supported by a hypervisor running on the hardware platform. In addition, the functionality of virtualization management server 10 may be implemented as one or more containers running on the operating system of a physical server, or inside a VM running a guest operating system.

Virtualization management server 10 monitors usage of compute resources by VMs running in the physical host computers and initiates migration of the VMs to balance resource usage across the physical host computers. Once migration is initiated, migration orchestrator 30 manages the migration process by communicating with migration modules running in the physical host computers.

In the example of FIG. 1, two physical host computers managed by virtualization management server 10 are illustrated for simplicity, but many more are managed by virtualization management server 10 in actual implementations. The two physical host computers illustrated include a source host 100 and a destination host 200. Source host 100 represents the physical host computer from which a VM is migrated and destination host 200 represents the physical host computer to which a VM is migrated.

Source host 100 includes a hardware platform 110 that provides physical resources including a CPU 112, system memory 113, which may be, for example, random-access memory (RAM), network interface controller (NIC) 114, storage 115, which may be, for example, a hard disk drive and a solid-state drive, a GPU 116, and local memory 117 associated with the GPU 116. Local memory 117 may, for example, be RAM.

A hypervisor 120 runs on the hardware platform 110 and provides drivers supporting the physical resources. Only one of these drivers, GPU driver 126, is depicted in FIG. 1. Hypervisor 120 also includes a migration module 124 that coordinates the migration process for source host 100 and a host daemon 128, which is a process that is called to instantiate VMs, such as VM 101.

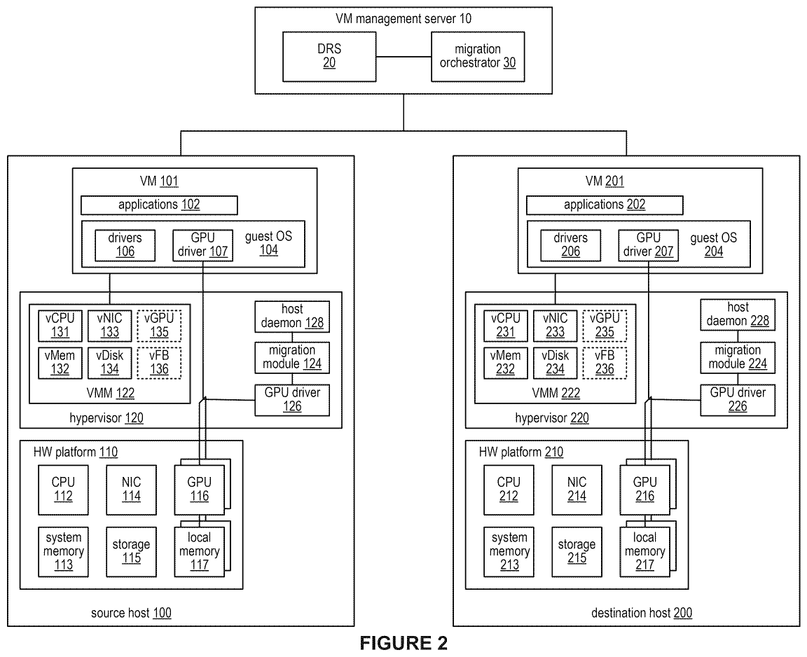

Hypervisor 120 further includes a virtual machine monitor VMM 122 that provides a set of virtual resources for VM 101. The virtual resources include a vCPU 131 that is provisioned from CPU 112, vMem 132 that is allocated from system memory 113, vNIC 133 that is provisioned from NIC 114, vDisk 134 that is allocated from blocks of storage 115, vGPU 135 that is provisioned from GPU 116, and virtual frame buffer (vFB) 136 that is allocated from local memory 117. VM 101 includes applications 102 running on top of a guest OS 104 that includes drivers 106 for the virtual resources, including a driver configured to communicate with vGPU 135. Unlike passthrough depicted in FIG. 2, control over physical GPU 116 is retained by the hypervisor 120 via GPU driver 126, which handles low-level execution of GPU commands. Guest-issued GPU instructions are passed through VMM 122 to GPU driver 126, which arbitrates among multiple VMs sharing GPU 116 and submits instructions to physical GPU 116. This setup ensures isolation and coordinated access while enabling efficient GPU virtualization.

Similarly, destination host 200 includes a hardware platform 210 that provides physical resources including a CPU 212, system memory 213, which may be, for example, RAM, NIC 214, storage 215, which may be, for example, a hard disk drive and a solid-state drive, a GPU 216, and local memory 217 associated with the GPU 216. Local memory 217 may, for example, be RAM.

A hypervisor 220 runs on the hardware platform 210 and provides drivers supporting the physical resources. Only one of these drivers, GPU driver 226, is depicted in FIG. 2. Hypervisor 220 also includes a migration module 224 that coordinates the migration process for destination host 200 and a host daemon 228, which is a process that is called to instantiate VMs, such as VM 201.

Hypervisor 220 further includes a virtual machine monitor VMM 222 that provides a set of virtual resources for VM 201. The virtual resources include a vCPU 231 that is provisioned from CPU 212, vMem 232 that is allocated from system memory 213, vNIC 233 that is provisioned from NIC 214, vDisk 234 that is allocated from blocks of storage 215, vGPU 235 that is provisioned from GPU 216, and vFB 236 that is allocated from local memory 217. VM 201 includes applications 202 running on top of a guest OS 204 that includes drivers 206 for the virtual resources, including a driver configured to communicate with vGPU 235.

FIG. 2 depicts a second example of a virtualized computing system in which a VM is migrated between a source host and a destination host. The example of FIG. 2 differs from the example of FIG. 1 in that the GPU is configured as a passthrough device. In this configuration, the VM is granted access to the physical GPU by the hypervisor via input-output memory management unit (IOMMU) mappings. In one embodiment, the VM's access to the physical GPU is exclusive and the physical GPU is not shared. In other embodiments, for example, where the physical GPU is sliced into multiple physical GPU instances, the physical GPU may be shared with one or more other VMs.

Therefore, on source host 100, guest OS 104 in VM 101 includes a GPU driver 107 that interfaces directly with GPU 116, bypassing hypervisor arbitration. The control path and data path both terminate directly at GPU 116, allowing applications 102 to leverage full GPU capabilities with minimal virtualization overhead. Hypervisor 120 remains responsible for setting up and tearing down access to GPU 116 during VM lifecycle events but is not involved in active I/O or command processing during normal operation. Accordingly, VM 101, when running workloads on GPU 116 accesses GPU 116 directly via GPU driver 107 provided by guest OS 104.

Similarly, on destination host 200, guest OS 204 in VM 201 includes a GPU driver 207 that interfaces directly with GPU 216, bypassing hypervisor arbitration. The control path and data path both terminate directly at GPU 216, allowing applications 202 to leverage full GPU capabilities with minimal virtualization overhead. Hypervisor 220 remains responsible for setting up and tearing down access to GPU 216 during VM lifecycle events but is not involved in active I/O or command processing during normal operation. Accordingly, VM 201, when running workloads on GPU 216 accesses GPU 216 directly via GPU driver 207 provided by guest OS 204.

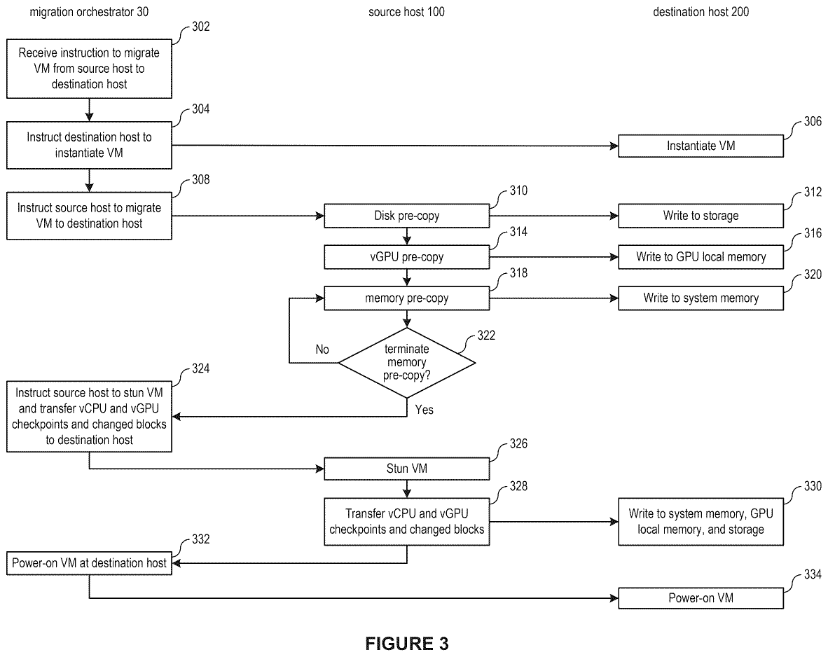

FIG. 3 is a flow diagram depicting a method of migrating a VM between hosts according to a first embodiment. In the method of FIG. 3, migration orchestrator 30 running in virtualization management server 10 communicates with migration module 124 running in source host 100 and migration module 224 running in destination host 200 to live migrate a VM running in source host 100 to destination host 200.

The method of FIG. 3 begins when migration orchestrator 30 receives an instruction to live migrate a particular VM between hosts (step 302). The instruction may come from another software component, such as DRS 20, or may originate from a user input, e.g., an administrator of the virtualized computing system. In the example illustrated herein, the instruction is to live migrate VM 101 running in source host 100 to destination host 200.

At step 304, migration orchestrator 30 instructs migration module 224 to instantiate a VM in destination host 200. In response to this instruction, migration module 224 at step 306 makes a request to host daemon 228 running in hypervisor 220 to instantiate VM 201. FIGS. 1 and 2 depict VM 201 after it has been instantiated.

At step 308, migration orchestrator 30 instructs migration module 124 to migrate VM 101 to destination host 200. The migration of VM 101 to destination host 200 entails transferring the entire of state of VM 101 to VM 201. The entire state of the VM 101 includes: (i) portions of system memory 113 allocated to VM 101, (ii) blocks of storage 115 allocated to vDisk 134, (iii) portions of local memory 117 allocated to vGPU 135, (iv) configuration information of VM 101 including virtual hardware and device mappings, (v) state information managed by hypervisor 120 including the execution state of vCPU 131 and vGPU 135, and (vi) device I/O states associated with VM 101, including network buffers, storage buffers, and transaction states. In response, migration module 124 performs a disk pre-copy at step 310, vGPU pre-copy at step 314, and an iterative memory pre-copy at steps 318 and 322, while VM 101 is running.

The disk pre-copy at step 310 includes transferring contents of blocks of storage 115 allocated to vDisk 134 to destination host 200 and, at destination host 200, writing the transferred contents to blocks of storage 215 allocated to vDisk 234 (step 312). If more than one vDisk is provisioned for VM 101, the disk pre-copy is performed for each additional vDisk sequentially in the same manner.

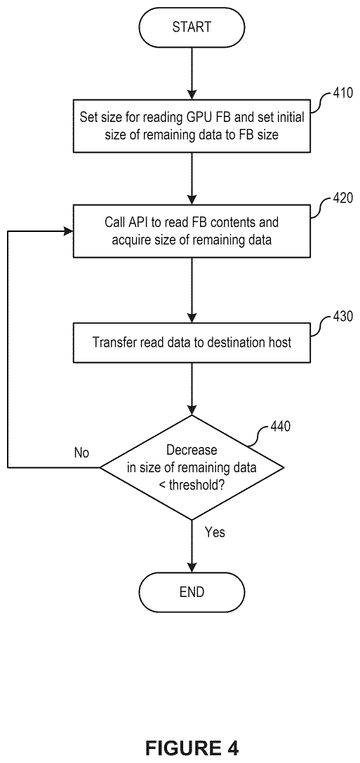

The vGPU pre-copy at step 314 includes transferring contents of portions of local memory 117 allocated to vGPU 135 to destination host 200 and, at destination host 200, writing the transferred contents to portions of local memory 217 allocated to vGPU 235 (step 316). If more than one vGPU is provisioned for VM 101, the vGPU pre-copy is performed for each additional vGPU sequentially in the same manner. Further details of the vGPU pre-copy step are described below in conjunction with FIG. 4.

The iterative memory pre-copy at steps 318 and 322 includes multiple iterations. Throughout the memory pre-copy, changes to each portion of system memory 113 allocated to vCPU 131 are tracked from the time it was last transferred to destination host 200. During the first iteration, the entire contents of the portions of system memory 113 allocated to vCPU 131 are transferred to destination host 200, where they are written to corresponding locations in system memory 213 allocated to vCPU 231. Because VM 101 continues to run during the transfer and the transfer is not instantaneous, some of the portions of system memory 113 allocated to vCPU 131 may change during the transfer. The contents of the portions that have changed are transferred to destination host 200 in a subsequent iteration. In addition, during each iteration of memory pre-copy, any changes to the blocks of vDisk 134 are mirrored to corresponding locations in storage 215.

At the conclusion of each iteration, step 322 is performed to determine whether the condition for terminating memory pre-copy has been met. This condition relates to the size of the remaining portions of system memory 113 that still need to be migrated, i.e., ones that have changed since their last transfer to destination host 200. The condition is met if the size of the remaining portions is sufficiently small—below a predetermined threshold—such that transferring their contents can be completed quickly enough after the VM is stunned, without external processes interacting with the VM perceiving any downtime. In some embodiments where the VM is very active, to achieve convergence more quickly, the VM is stunned for a brief period of time that is short enough to prevent external processes from perceiving any downtime, to slow down the rate of writing to system memory 113.

When the condition for terminating memory pre-copy is met at step 322, migration module 124 notifies migration orchestrator 30, which in turn instructs source host 100 to stun VM 101 and transfer vCPU and vGPU checkpoints and changed blocks of vDisk to destination host 200. The vCPU checkpoint includes the contents of all portions of system memory 113 allocated to vCPU 131 that have been modified since they were last transferred to destination host 200. The vGPU checkpoint includes the contents of all portions of local memory 117 allocated to vGPU 135 that have been modified since they were last transferred to destination host 200. The changed blocks include the contents of all blocks of vDisk 134 that have been modified since they were last transferred to destination host 200. In response to the instruction issued at step 324, source host 100 stuns VM 101 at step 326, and transfers the vCPU and vGPU checkpoints and changed blocks of vDisk 134 to destination host 200 at step 328. At step 330, the transferred vCPU and vGPU checkpoints and changed blocks of vDisk 134 are written to corresponding locations in system memory 213, local memory 217, and storage 215.

At 332, after the transfer of the vCPU and vGPU checkpoints and changed blocks of vDisk 134 to destination host 200, migration orchestrator 30 instructs destination host 200 to power-on VM 201. In response, destination host 200 powers on VM 201 and thereafter all external processes that interacted with VM 101 prior to migration continue to interact with VM 201 after migration, such that, from the perspective of the external processes, interaction appears to continue seamlessly with the same VM before and after the migration.

FIG. 4 is a flow diagram depicting in detail the vGPU pre-copy step 314. In one embodiment, this step is performed by migration module 124 requesting GPU driver 126, e.g., via an API call (hereinafter referred to as read_device_buffer API), to read a fixed amount of data from local memory 117, starting with the “cold” data, and return them along with an indication of how many bytes remain to be read. As used herein, data is “cold” if its update frequency is below a threshold, and data is “hot” if its update frequency is above the threshold. In response to the request, GPU driver 126 reads the data from local memory 117 and returns it to migration module 124 along with the indication of how many bytes remain to be read.

The method of FIG. 4 begins at step 410 where the data size for reading is set to a fixed number, e.g., 100 MB, and the initial number of bytes remaining to be read is set to the size of portions of local memory 117 allocated to GPU 116. Then, at step 420, migration module 124 makes a read_device_buffer API call to GPU driver 126, which in response thereto, returns 100 MB of data along with an indication of how many bytes remain to be read. At step 430, migration module 124 transfers the read data to destination host 200.

Step 440 represents the termination condition for the method of FIG. 4. If the number of bytes remaining to be read continues to go down in 100 MB increments, this is an indication that cold data is continually being read from the portions of local memory 117 allocated to GPU 116. Therefore, in such a situation, the flow returns to step 420 for another 100 MB of data to be requested via the API call to GPU driver 126. On the other hand, if the decrease in the number of bytes remaining to be read is less than a threshold (e.g., 10 MB), this is an indication that what remains in the portions of local memory 117 allocated to GPU 116 is not cold data. In this situation, the process terminates and the vGPU pre-copy step 314 ends. The threshold of 10 MB may be set to a different number based on the available network bandwidth and the dirty rate of the frame buffer, which is a measure of how frequently memory pages of the frame buffer are modified per unit time.

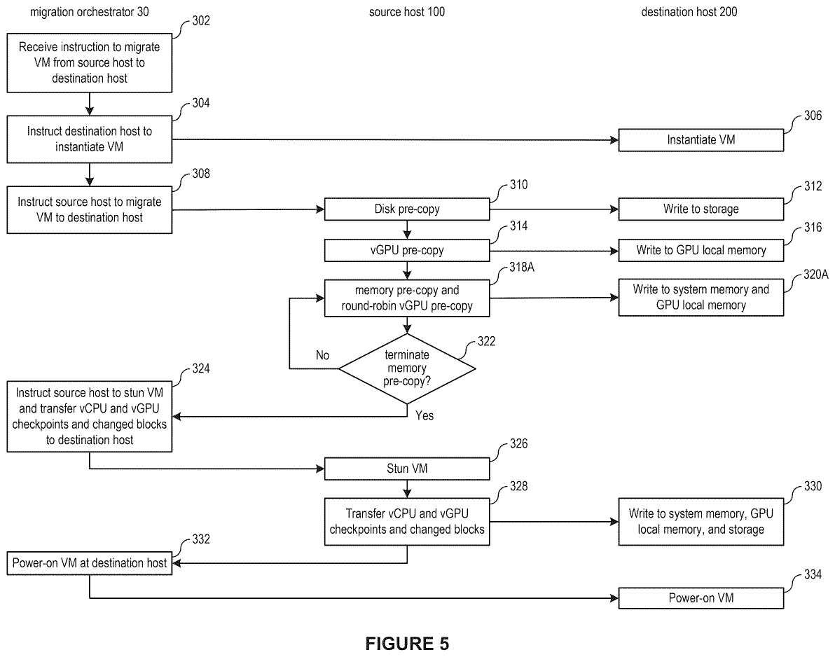

FIG. 5 is a flow diagram depicting a method of migrating a VM between hosts according to a second embodiment. The second embodiment differs from the first embodiment in that step 318 is replaced with step 318A and step 320 is replaced with step 320A. All other steps are the same between the two embodiments.

In step 318A, during each iteration of the memory pre-copy, migration module 124 makes a read_device_buffer API call to GPU driver 126 to read non-cold data from the portions of local memory 117 allocated to GPU 116. In addition, migration module 124 transfers the non-cold data that is read to destination host 200, and destination host at step 320A writes the transferred non-cold data to portions of local memory 217 allocated to GPU 216. In cases where the VM being migrated has multiple vGPUs and multiple frame buffers, for each new iteration, non-cold data is read from one of the frame buffers that are selected in a round-robin manner, i.e., the frame buffers are chosen in a fixed cyclic order, one at a time.

By introducing the vGPU pre-copy in the embodiments described above, the time for transferring the vGPU checkpoint was reduced by 65% to 80% for certain vGPU workloads, including generative AI workloads.

In the embodiments described above, the storage for the migrated VM resides in the source host. In some embodiments, the storage for the migrated VM may reside in a storage device that is shared between the source host and the destination host. In such cases, the disk pre-copy step and the transfer of changed blocks do not need to be performed. In addition, the embodiments described above may be practiced with co-processors other than GPUs. GPUs and such other co-processors are defined herein as “special” processing units.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A computer system comprising:
a first host computer on which a virtual machine (VM) is executing, the first host computer having a first hardware platform including a physical central processing unit (CPU), a physical graphics processing unit (GPU), and physical memory resources, and the VM including a virtual CPU provisioned from the physical CPU, a system memory allocated for the virtual CPU from the physical memory resources, a virtual GPU associated with the physical GPU, and a frame buffer allocated for the virtual GPU from the physical memory resources;
a second host computer having a second hardware platform including a physical CPU, a physical GPU, and physical memory resources; and
computer software executing on the first and second host computers, the computer software implementing a method for migrating the VM to the second host computer, the method comprising:
while the VM is executing on the first host computer,
selectively reading cold data from the frame buffer and transferring the selectively read cold data from the physical memory resources of the first host computer to the physical memory resources of the second host computer, and then
iteratively transferring contents of the system memory from the physical memory resources of the first host computer to the physical memory resources of the second host computer, and tracking portions of the system memory that are modified since the contents thereof were transferred, wherein said iteratively transferring includes a first step of transferring the entire contents of the system memory from the physical memory resources of the first host computer to the physical memory resources of the second host computer and one or more subsequent steps of transferring the contents of the modified portions of the system memory from the physical memory resources of the first host computer to the physical memory resources of the second host computer;
suspending the execution of the VM on the first host computer; and
while the execution of the VM on the first host computer is suspended, reading remaining data to be transferred from the frame buffer and transferring the remaining data read from the frame buffer and the contents of the modified portions of the system memory, from the physical memory resources of the first host computer to the physical memory resources of the second host computer.

2. The computer system of claim 1, wherein selectively reading the cold data from the frame buffer and transferring the selectively read cold data includes the steps of:
(a) reading a portion of the cold data from the frame buffer and transferring the read portion; and
(b) determining the remaining data to be transferred from the frame buffer,
wherein steps (a) and (b) are repeated until the remaining data to be transferred does not decrease by at least a threshold.

3. The computer system of claim 1, wherein the method further comprises:
while the VM is executing on the first host computer and after the cold data are selectively read and transferred, for each iteration during which the contents of the system memory are transferred from the physical memory resources of the first host computer to the physical memory resources of the second host computer, reading a portion of the remaining data to be transferred from the frame buffer and transferring the read portion from the physical memory resources of the first host computer to the physical memory resources of the second host computer.

4. The computer system of claim 3, wherein
the first hardware platform includes a plurality of physical GPUs, and the VM includes a plurality of virtual GPUs, each associated with one of the physical GPUs, and a plurality of frame buffers, each allocated for one of the virtual GPUs from the physical memory resources, and
during each iteration, one of the plurality of frame buffers is selected in a round-robin manner, and the portion of the remaining data that is transferred from the physical memory resources of the first host computer to the physical memory resources of the second host computer is read from the selected frame buffer.

5. The computer system of claim 3, wherein
during each iteration of transferring the contents of the system memory from the physical memory resources of the first host computer to the physical memory resources of the second host computer, pausing the execution of the VM on the first host computer for a preset time period.

6. The computer system of claim 1, wherein the virtual machine has a guest OS running therein and the guest OS includes a driver for the physical GPU that is directly interfaced with the physical GPU and accepts commands for the virtual GPU.

7. The computer system of claim 1, wherein the virtual GPU is provisioned from the physical GPU, and the virtual machine has a guest OS running therein and the guest OS includes a driver for the virtual GPU that accepts commands for the virtual GPU.

8. The computer system of claim 1, wherein the physical memory resources of the first host computer include a first memory that is local to the physical CPU and a second memory that is local to the physical GPU, and wherein the system memory is allocated from the first memory and the frame buffer is allocated from the second memory.

9. A method of migrating a virtual machine (VM) that is executing on a first host computer having a physical central processing unit (CPU), a physical graphics processing unit (GPU), and physical memory resources, to a second host computer, wherein the VM includes a virtual CPU provisioned from the physical CPU, a system memory allocated for the virtual CPU from the physical memory resources, a virtual GPU associated with the physical GPU, and a frame buffer allocated for the virtual GPU from the physical memory resources, said method comprising:
while the VM is executing on the first host computer,
selectively reading cold data from the frame buffer and transferring the selectively read cold data from the physical memory resources of the first host computer to physical memory resources of the second host computer, and then
iteratively transferring contents of the system memory from the physical memory resources of the first host computer to the physical memory resources of the second host computer, and tracking portions of the system memory that are modified since the contents thereof were transferred, wherein said iteratively transferring includes a first step of transferring the entire contents of the system memory from the physical memory resources of the first host computer to the physical memory resources of the second host computer and one or more subsequent steps of transferring the contents of the modified portions of the system memory from the physical memory resources of the first host computer to the physical memory resources of the second host computer;
suspending the execution of the VM on the first host computer; and
while the execution of the VM on the first host computer is suspended, reading remaining data to be transferred from the frame buffer and transferring the remaining data read from the frame buffer and the contents of the modified portions of the system memory, from the physical memory resources of the first host computer to the physical memory resources of the second host computer.

10. The method of claim 9, wherein selectively reading the cold data from the frame buffer and transferring the selectively read cold data includes the steps of:
(a) reading a portion of the cold data from the frame buffer and transferring the read portion; and
(b) determining the remaining data to be transferred from the frame buffer,
wherein steps (a) and (b) are repeated until the remaining data to be transferred does not decrease by at least a threshold.

11. The method of claim 9, further comprising:
while the VM is executing on the first host computer and after the cold data are selectively read and transferred, for each iteration during which the contents of the system memory are transferred from the physical memory resources of the first host computer to the physical memory resources of the second host computer, reading a portion of the remaining data to be transferred from the frame buffer and transferring the read portion from the physical memory resources of the first host computer to the physical memory resources of the second host computer.

12. The method of claim 11, wherein
the first host computer includes a plurality of physical GPUs, and the VM includes a plurality of virtual GPUs, each associated with one of the physical GPUs, and a plurality of frame buffers, each allocated for one of the virtual GPUs from the physical memory resources, and
during each iteration, one of the plurality of frame buffers is selected in a round-robin manner, and the portion of the remaining data that is transferred from the physical memory resources of the first host computer to the physical memory resources of the second host computer is read from the selected frame buffer.

13. The method of claim 11, wherein
during each iteration of transferring the contents of the system memory from the physical memory resources of the first host computer to the physical memory resources of the second host computer, pausing the execution of the VM on the first host computer for a preset time period.

14. The method of claim 9, wherein the virtual machine has a guest OS running therein and the guest OS includes a driver for the physical GPU that is directly interfaced with the physical GPU and accepts commands for the virtual GPU.

15. The method of claim 9, wherein the virtual GPU is provisioned from the physical GPU, and the virtual machine has a guest OS running therein and the guest OS includes a driver for the virtual GPU that accepts commands for the virtual GPU.

16. The method of claim 9, wherein the physical memory resources of the first host computer include a first memory that is local to the physical CPU and a second memory that is local to the physical GPU, and wherein the system memory is allocated from the first memory and the frame buffer is allocated from the second memory.

17. A computer system comprising:
a first host computer on which a virtual machine (VM) is executing, the first host computer having a first hardware platform including a physical central processing unit (CPU), a physical special processing unit (SPU), and physical memory resources, and the VM including a virtual CPU provisioned from the physical CPU, a system memory allocated for the virtual CPU from the physical memory resources, a virtual SPU associated with the physical SPU, and a frame buffer allocated for the virtual SPU from the physical memory resources;
a second host computer having a second hardware platform including a physical CPU, a physical SPU, and physical memory resources; and
computer software executing on the first and second host computers, the computer software implementing a method for migrating the VM to the second host computer, the method comprising:
while the VM is executing on the first host computer,
selectively reading cold data from the frame buffer and transferring the selectively read cold data from the physical memory resources of the first host computer to the physical memory resources of the second host computer, and then iteratively transferring contents of the system memory from the physical memory resources of the first host computer to the physical memory resources of the second host computer, and tracking portions of the system memory that are modified since the contents thereof were transferred, wherein said iteratively transferring includes a first step of transferring the entire contents of the system memory from the physical memory resources of the first host computer to the physical memory resources of the second host computer and one or more subsequent steps of transferring the contents of the modified portions of the system memory from the physical memory resources of the first host computer to the physical memory resources of the second host computer;
suspending the execution of the VM on the first host computer; and
while the execution of the VM on the first host computer is suspended, reading remaining data to be transferred from the frame buffer and transferring the remaining data read from the frame buffer and the contents of the modified portions of the system memory, from the physical memory resources of the first host computer to the physical memory resources of the second host computer.

18. The computer system of claim 17, wherein selectively reading the cold data from the frame buffer and transferring the selectively read cold data includes the steps of:
(a) reading a portion of the cold data from the frame buffer and transferring the read portion; and
(b) determining the remaining data to be transferred from the frame buffer,
wherein steps (a) and (b) are repeated until the remaining data to be transferred does not decrease by at least a threshold.

19. The computer system of claim 17, wherein the method further comprises:
while the VM is executing on the first host computer and after the cold data are selectively read and transferred, for each iteration during which the contents of the system memory are transferred from the physical memory resources of the first host computer to the physical memory resources of the second host computer, reading a portion of the remaining data to be transferred from the frame buffer and transferring the read portion from the physical memory resources of the first host computer to the physical memory resources of the second host computer.

20. The computer system of claim 17, wherein the physical memory resources of the first host computer include a first memory that is local to the physical CPU and a second memory that is local to the physical SPU, and wherein the system memory is allocated from the first memory and the frame buffer is allocated from the second memory.
